(19) United States
(12) Patent Application Publication
(10) Pub. No.: US 2025/0214599 A1
(43) Pub. Date: Jul. 3, 2025

(54) VEHICLE CONTROL METHOD, VEHICLE CONTROL DEVICE, AND STORAGE MEDIUM

(71) Applicant: HONDA MOTOR CO., LTD., Tokyo (JP)

(72) Inventor: Yoshihiro Oniwa, Tokyo (JP)

(21) Appl. No.: 19/000,875

(22) Filed: Dec. 24, 2024

(30) Foreign Application Priority Data
Dec. 28, 2023 (JP) 2023-223055

(51) Int. Cl. B60W 50/08; B60W 30/09; B60W 30/095; B60W 50/00

(52) U.S. Cl. CPC B60W 50/082; B60W 30/09; B60W 30/0956; B60W 2050/0073; B60W 2510/202; B60W 2520/10; B60W 2540/106; B60W 2540/223

(57) ABSTRACT

A vehicle control method of an embodiment includes, by a computer, recognizing surrounding conditions of a vehicle, detecting a steering state of an occupant of the vehicle, detecting a speed operation of the vehicle, determining that there is a possibility of contact between the vehicle and an obstacle on the basis of the recognized surrounding conditions, executing avoidance steering assistance to avoid contact with the obstacle when a steering amount equal to or greater than a first threshold value is detected based on the detected steering state of the occupant, executing stop control to stop the avoidance steering assistance when a speed operation equal to or greater than a second threshold value is detected based on the detected speed operation during the execution of the avoidance steering assistance, and suppressing execution of the stop control when a predetermined condition is satisfied during the execution of the avoidance steering assistance.

### CROSS-REFERENCE TO RELATED APPLICATION

Priority is claimed on Japanese Patent Application No. 2023-223055, filed Dec. 28, 2023, the content of which is incorporated herein by reference.

### BACKGROUND

### Field of the Invention

The present invention relates to a vehicle control method, a vehicle control device, and a storage medium.

### Description of Related Art

In recent years, there has been increased effort to provide access to sustainable transport systems that take into consideration vulnerable transport participants. To realize this, research and development to further improve the safety and convenience of traffic through research and development related to preventive safety technologies has mainly been focused upon. In relation to this, in recent years, a driving control device has been disclosed that changes the override threshold value, which is the criterion for determining whether to intervene in an operation to stop an automated lane changing function when a vehicle deviates from a system operation design area, to a value larger than that under normal circumstances within the system operation design area (for example, Japanese Unexamined Patent Application, First Publication No. 2020-132045).

### SUMMARY OF THE INVENTION

However, in the preventive safety technology, no consideration has been given to how to design the override threshold value at which steering assistance control to avoid contact between the vehicle and an obstacle is stopped. For this reason, there is a problem that appropriate driving assistance may not be possible during the steering assistance control to avoid contact with the obstacle.

To solve the problem described above, one of the objectives of the present application is to provide a vehicle control method, a vehicle control device, and a storage medium that can perform more appropriate driving assistance control in situations where contact with an obstacle is to be avoided. This will ultimately contribute to the development of a sustainable transportation system.

The vehicle control method, the vehicle control device, and the storage medium according to the present invention have adopted the following configuration.

(1): A vehicle control method according to one aspect of the present invention includes, by a computer, recognizing surrounding conditions of a vehicle, detecting a steering state of an occupant of the vehicle, detecting a speed operation of the vehicle by the occupant, determining that there is a possibility of contact between the vehicle and an obstacle on the basis of the recognized surrounding conditions of the vehicle, executing avoidance steering assistance to avoid contact with the obstacle when a steering amount equal to or greater than a first threshold value is detected based on the detected steering state of the occupant, executing stop control to stop the avoidance steering assistance when a speed operation equal to or greater than a second threshold value is detected based on the detected speed operation during the execution of the avoidance steering assistance, and suppressing execution of the stop control when a predetermined condition is satisfied during the execution of the avoidance steering assistance.

(2): In the aspect of (1) described above, the predetermined condition may include a predetermined time from a start of the avoidance steering assistance.

(3): In the aspect of (1) described above, the predetermined condition may include a steering amount equal to or greater than a third threshold value, which is greater than the first threshold value, detected based on the steering state.

(4): In the aspect of (1) described above, the computer may set, when the execution of the stop control is suppressed, a value of the second threshold value to be larger than when the execution of the stop control is not suppressed.

(5): In the aspect of (4) described above, the speed operation may include an operation of an accelerator pedal of the vehicle, and the second threshold value may be a threshold value for an opening of the accelerator pedal.

(6): In the aspect of (4) described above, the speed operation may include an operation of an accelerator pedal of the vehicle, and the second threshold value may be a threshold value for a rate of change in an opening of the accelerator pedal.

(7): In the aspect of (1) described above, the computer may not execute the stop control when the predetermined condition is satisfied during the execution of the avoidance steering assistance.

(8): In the aspect of (1) described above, the computer may not execute a determination regarding suppression of the stop control using a rate of change in an opening of an accelerator pedal of the vehicle when the predetermined condition is satisfied during the execution of the avoidance steering assistance.

(9): In the aspect of (1) described above, the speed operation may include an operation related to an opening of an accelerator pedal of the vehicle and a rate of change in the opening of the accelerator pedal.

(10): A vehicle control device according to another aspect of the present invention includes a recognizer configured to recognize surrounding conditions of a vehicle, a steering state detector configured to detect a steering state of an occupant of the vehicle, a speed operation detector configured to detect a speed operation of the vehicle by the occupant, a steering controller configured to determine that there is a possibility of contact between the vehicle and an obstacle on the basis of the recognized surrounding conditions of the vehicle, and to execute avoidance steering assistance to avoid contact with the obstacle when a steering amount equal to or greater than a first threshold value is detected based on the detected steering state of the occupant, and a stop controller configured to execute stop control to stop the avoidance steering assistance when a speed operation equal to or greater than a second threshold value is detected based on the speed operation detected by the speed operation detector during execution of the avoidance steering assistance, in which the stop controller suppresses execution of the stop control when a predetermined condition is satisfied during the execution of the avoidance steering assistance.

(11): A computer-readable non-transitory storage medium according to still another aspect of the present invention has stored a program causing a computer to execute recognizing surrounding conditions of a vehicle, detecting a steering state of an occupant of the vehicle, detecting a speed operation of the vehicle by the occupant, determining that there is a possibility of contact between the vehicle and an obstacle on the basis of the recognized surrounding conditions of the vehicle, executing avoidance steering assistance to avoid contact with the obstacle when a steering amount equal to or greater than a first threshold value is detected based on the detected steering state of the occupant, executing stop control to stop the avoidance steering assistance when a speed operation equal to or greater than a second threshold value is detected based on the detected speed operation during the execution of the avoidance steering assistance, and suppressing execution of the stop control when a predetermined condition is satisfied during the execution of the avoidance steering assistance.

According to the aspects of (1) to (11) described above, it is possible to perform more appropriate driving assistance control in a situation of avoiding contact with an obstacle.

### BRIEF DESCRIPTION OF THE DRAWINGS

FIG. 1 is a configuration diagram of a vehicle in which a vehicle control device of an embodiment is mounted.

FIG. 2 is a functional configuration diagram of a driving state detector.

FIG. 3 is a functional configuration diagram of a vehicle controller.

FIG. 4 is a diagram for describing content of vehicle control related to contact avoidance.

FIG. 5 is a diagram for describing content of attention calling control.

FIG. 6 is a diagram for describing content of contact attention warning control.

FIG. 7 is a diagram for describing content of automated steering avoidance control.

FIG. 8 is a diagram for describing steering control after a driver steering trigger.

FIG. 9 is a diagram for describing driver steering assistance and stop control executed by the vehicle controller.

FIG. 10 is a diagram for describing vehicle control when an accelerator operation is executed after a predetermined time AT has elapsed since a start of driver steering assistance control.

FIG. 11 is a flowchart which shows an example of processing executed by a driving assistance device in the embodiment.

FIG. 12 is a flowchart which shows an example of stop control processing.

### DESCRIPTION OF EMBODIMENTS

Hereinafter, embodiments of a vehicle control method, a vehicle control device, and a program of the present invention will be described with reference to the drawings.

### Overall Configuration

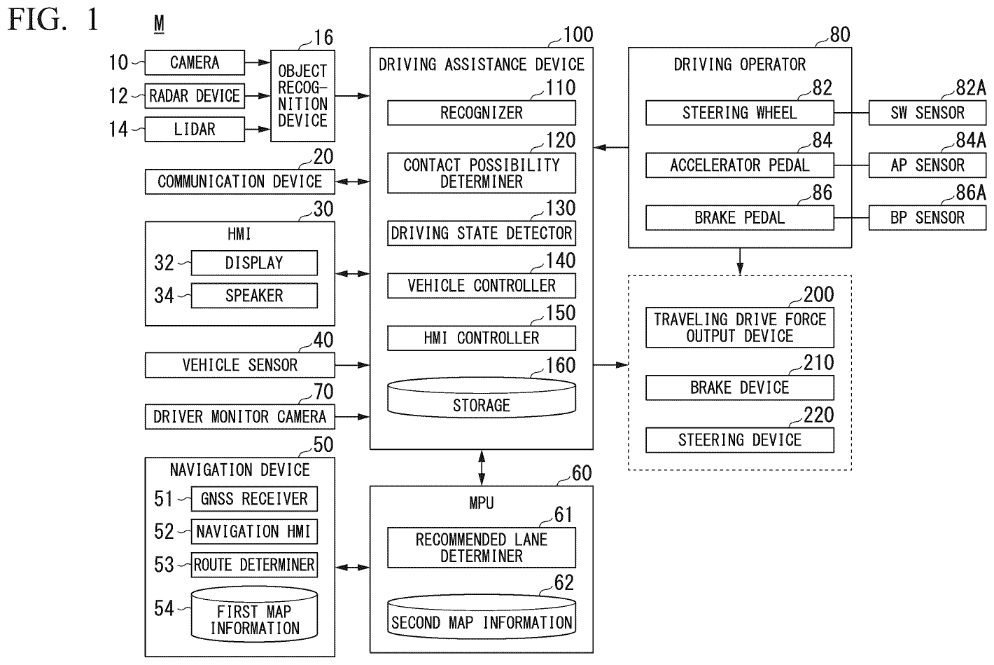

FIG. 1 is a configuration diagram of a vehicle (hereinafter referred to as a host vehicle M) in which a vehicle control device of an embodiment is mounted. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

For example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, a driving assistance device 100, a traveling drive force output device 200, a brake device 210, and a steering device 220 are mounted in the host vehicle M. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added. The driving assistance device 100 is an example of the “vehicle control device.”

The camera 10 is a digital camera that uses a solid-state image sensor such as a charge coupled device (CCD) or a complementary metal oxide semiconductor (CMOS). The camera 10 is attached to an arbitrary place in the host vehicle M. When an image of in front of the host vehicle M is captured, the camera 10 is attached to an upper portion of the front windshield, a back surface of the windshield rear-view mirror, and the like. The camera 10 periodically and repeatedly captures an image of, for example, a vicinity of the host vehicle M. The camera 10 may be a stereo camera

The radar device 12 radiates radio waves such as millimeter waves to the vicinity of the host vehicle M, and also detects at least a position (a distance and a direction) of an object by detecting radio waves (reflected waves) reflected by the object. The radar device 12 is attached to an arbitrary place on the host vehicle M. The radar device 12 may detect the position and speed of an object in a frequency modulated continuous wave (FM-CW) method.

The LIDAR 14 irradiates the vicinity of the host vehicle M with light (or electromagnetic waves with wavelengths close to that of light) and measures scattered light. The LIDAR 14 detects a distance to a target based on a time from light emission to light reception. The irradiated light is, for example, a pulsed laser beam. The LIDAR 14 is attached to an arbitrary place on the host vehicle M.

The object recognition device 16 performs sensor fusion processing on a result of detection by some or all of the camera 10, the radar device 12, and the LIDAR 14, and recognizes the position, type, speed, and the like of an object. The object recognition device 16 outputs a result of recognition to the driving assistance device 100. The object recognition device 16 may output the results of detection by the camera 10, the radar device 12, and the LIDAR 14 to the driving assistance device 100 as they are. The object recognition device 16 may be omitted from the host vehicle M. Some or all of the camera 10, the radar device 12, the LIDAR 14, and the object recognition device 16 are examples of an “external detection device.”

The communication device 20 communicates with other vehicles present in the vicinity of host the host vehicle M by using, for example, a cellular network, a Wi-Fi network, Bluetooth (a registered trademark), dedicated short range communication (DSRC), or the like, or communicates with various server devices via a wireless base station.

The HMI 30 presents various types of information to the occupant of the host vehicle M and receives an input operation from the occupant. The HMI 30 includes, for example, a display 32 and a speaker 34. The display 32 is, for example, a liquid crystal display (LCD) or an organic electro luminescence (EL) display device. The display 32 displays various images (including videos) in the embodiment. The display 32 may be integrated with an input as a touch panel. The speaker 34 outputs a predetermined sound (for example, a warning, or the like). In addition to (or instead of) the display 32 and the speaker 34, the HMI 30 may be a microphone, a buzzer, a vibration generator (vibrator), a touch panel, a switch, a key, or the like. The switch may include, for example, a changeover switch that switches between whether to execute a predetermined driving assistance in the driving assistance device 100.

The vehicle sensor 40 includes a speed sensor that detects a speed of the host vehicle M, an acceleration sensor that detects the acceleration, a yaw rate sensor that detects the yaw rate (for example, the rotational angular speed around a vertical axis passing through the center of gravity of host vehicle M), a steering angle sensor that detects the steering angle (an angle (an actual steering angle) or a torque amount of a steering wheel of the host vehicle M), and an orientation sensor that detects a direction of the host vehicle M. The vehicle sensor 40 may be provided with a position sensor that detects the position of the host vehicle M. The position sensor is, for example, a sensor that acquires position information (longitude and latitude information) from a global positioning system (GPS) device. The position sensor may also be a sensor that acquires position information using a global navigation satellite system (GNSS) receiver 51 of the navigation device 50.

The navigation device 50 includes, for example, a GNSS receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M based on a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the host vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the host vehicle M can travel on a reasonable route to proceed to the branch destination. The second map information 62 is map information with higher accuracy than the first map information 54. The second map information 62 includes, for example, information on a center of a lane, or lane boundary information such as a road dividing line that divides a lane. The second map information 62 may include road information, traffic regulation information, address information (address and postal code), facility information, telephone number information, and the like. The second map information 62 may be updated at any time by the communication device 20 communicating with another device. The first map information 54 and the second map information 62 may be stored in a storage in the driving assistance device 100.

The driver monitor camera 70 is, for example, a digital camera using a solid-state imaging device such as a CCD or CMOS. The driver monitor camera 70 is attached to any place on the host vehicle M, which is a position and a direction at which the head and upper body (including the hand position) of an occupant (hereafter referred to as a driver) seated in a driver's seat of the host vehicle M can be imaged from the front (in a direction for imaging the face). For example, the driver monitor camera 70 is attached to an upper portion of a display device provided in a center portion of an instrument panel of the host vehicle M. For example, on the basis of a direction of the face of the driver included in the camera image captured by the driver monitor camera 70 (a direction of the face relative to a mounting position and a shooting direction of the driver monitor camera 70), it is possible to determine whether the driver is paying attention to surroundings of the host vehicle M (for example, whether the face of the driver is at least facing a traveling direction of the host vehicle M). On the basis of a posture of the driver included in the camera image, it is possible to determine whether the posture of the driver is disturbed (in other words, whether the posture of the driver is disturbed and the driver is likely to perform an unintended driving operation). Since the camera image includes the driver and the steering wheel 82, it is possible to determine, based on the captured image, whether the driver is gripping the steering wheel 82. The driver monitor camera 70 captures an image of an interior of a compartment of the host vehicle M including the driver from a position where it is placed at a predetermined cycle and outputs the captured image to the driving assistance device 100.

The driving operator 80 includes, for example, the steering wheel 82, an accelerator pedal 84, a brake pedal 86, an operation switch of a turn signal, a shift lever, and other operators. The driving operator 80 has a sensor that detects the amount of operation or a presence or absence of an operation attached thereto, and a result of detection is output to the driving assistance device 100, or some or all of the traveling drive force output device 200, the brake device 210, and the steering device 220.

For example, the steering wheel 82 is provided with a steering wheel (an SW sensor) 82A. The SW sensor 82A detects whether the driver is gripping the steering wheel 82 by using a contact sensor, a pressure sensor, or the like. The SW sensor 82A detects the amount of operation (an amount of steering, a steering input torque, or a steering torque) and an operation speed (a steering angular speed) of the steering wheel 82 input (operated) by the driver. The SW sensor 82A may detect an operation change rate (a torque change rate). The steering wheel 82 does not necessarily have to be annular, and may be in a form of an irregular steering wheel, a joystick, a button, or the like. In that case, the SW sensor 82A detects the amount of operation according to each form.

An accelerator pedal sensor (an AP sensor) 84A is attached to the accelerator pedal 84. The AP sensor 84A detects the amount of operation (an opening) of the accelerator pedal 84, which changes in response to the driver's operation of the accelerator pedal 84. The brake pedal 86 is provided with a brake pedal sensor (BP sensor) 86A. The BP sensor 86A detects the amount of operation (the opening) of the brake pedal 86, which changes in response to the driver's operation of the brake pedal 86. The AP sensor 84A and the BP sensor 86A may detect a rate of change in the opening (a rate of change in the opening) over a predetermined time.

The traveling drive force output device 200 outputs a traveling drive force (torque) for the host vehicle M to travel to drive wheels. The traveling drive force output device 200 includes, for example, a combination of an internal combustion engine, an electric motor, a transmission, and the like, and an electronic control unit (ECU) that controls these. The ECU controls the constituents according to information input from the driving assistance device 100 or information input from the driving operator 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor according to the information input from the driving assistance device 100 or the information input from the driving operator 80, so that a brake torque corresponding to a braking operation is output to each wheel. The brake device 210 may include a mechanism that transmits a hydraulic pressure generated by operating the brake pedal included in the driving operator 80 to the cylinder via a master cylinder as a backup. The brake device 210 is not limited to the configuration described above, and may be an electronically controlled hydraulic brake device that controls an actuator according to the information input from the driving assistance device 100 and transmits the hydraulic pressure of the master cylinder to the cylinder.

The steering device 220 includes, for example, a steering ECU and an electric motor. The electric motor applies force to, for example, a rack and pinion mechanism to change a direction of steering wheels. The steering ECU drives the electric motor according to the information input from the driving assistance device 100 or the information input from the driving operator 80 to change the direction of the steering wheels.

### Driving Assistance Device

The driving assistance device 100 includes, for example, a recognizer 110, a contact possibility determiner 120, a driving state detector 130, a vehicle controller 140, an HMI controller 150, and a storage 160. The recognizer 110, the contact possibility determiner 120, the driving state detector 130, the vehicle controller 140, and the HMI controller 150 are realized by, for example, a hardware processor such as a central processing unit (CPU) executing a program (software). Some or all of these components may be realized by hardware (a circuit; including circuitry) such as large scale integration (LSI), an application specific integrated circuit (ASIC), a field-programmable gate array (FPGA), or a graphics processing unit (GPU), or may be realized by software and hardware in cooperation. The program may be stored in advance in a storage device (a storage device having a non-transient storage medium) such as an HDD or flash memory of the driving assistance device 100, or may be stored in a detachable storage medium such as a DVD or CD-ROM, and installed in the HDD or flash memory of the driving assistance device 100 by mounting the storage medium (non-transient storage medium) in a drive device. The HMI controller 150 is an example of a “notification controller.”

For example, the traveling drive force output device 200, the brake device 210, and the steering device 220 are set so that an instruction from the driving assistance device 100 to the traveling drive force output device 200, the brake device 210, and the steering device 220 are executed with priority over a result of the detection from the driving operator 80. Regarding braking, when a braking force based on the operation amount of the brake pedal 86 is greater than the instruction from the driving assistance device 100, the latter may be set to be executed with priority. As a mechanism for executing the instruction from the driving assistance device 100 with priority, a communication priority in an in-vehicle local area network (LAN) may be used. Regarding steering, a steering force based on the instruction from the driving assistance device 100 and a steering force based on the operation amount of the steering wheel 82 by the driver may be set to be added together and executed.

The storage 160 may be realized by the various storage devices described above, or a solid state drive (SSD), an electrically erasable programmable read only memory (EEPROM), a read only memory (ROM), or a random access memory (RAM). The storage 160 stores, for example, a program (for example, a program for vehicle control), information used in components of the driving assistance device 100, various other types of information, and the like. The storage 160 may store the map information described above (the first map information 54 and the second map information 62).

The recognizer 110 recognizes the surrounding conditions of the host vehicle M on the basis of information input from an external detection device. For example, the recognizer 110 recognizes states, such as a position (a relative position or an inter-vehicle distance), a speed (a relative speed), and an acceleration, of an object present in the vicinity (for example, within a predetermined distance from the host vehicle M). The object is, for example, another vehicle, a bicycle, a pedestrian, or the like. The position of the object is recognized as a position on an absolute coordinate system with a representative point of the host vehicle M (a center of gravity, a center of drive shaft, or the like) as the origin, and is used for control. The position of the object may be represented by a representative point such as the center of gravity or a corner of the object, or may be represented by an area. The “states” of the object may include the acceleration or jerk of the object, or an “action state” (for example, whether the object is changing lanes or is about to change lanes). The recognizer 110 recognizes the relative position and relative speed with respect to the object.

The recognizer 110 recognizes a shape of lanes in the vicinity of the host vehicle M. For example, the recognizer 110 compares a pattern of a road dividing line (for example, an arrangement of solid and dashed lines) obtained from the second map information 62 with a pattern of a road dividing line in the vicinity of the host vehicle M recognized from an image captured by the camera 10 to recognize the shape and a line type of a lane in which the host vehicle M is traveling (a traveling lane) and adjacent lanes adjacent to the traveling lane. The recognizer 110 may recognize the traveling lane and adjacent lanes by recognizing the road dividing line and traveling path boundaries (road boundaries) including road shoulders, curbs, medians, guardrails, and the like, in addition to the road dividing line. In this recognition, the position of the host vehicle M obtained from the navigation device 50 and a result of the processing by the INS may be taken into consideration. The recognizer 110 recognizes obstacles, stop lines, red lights, toll booths, and other road events from a result of the recognition of the object. The obstacle is an object with which the host vehicle M needs to avoid contact, and includes, for example, another vehicle, a bicycle, a pedestrian, and the like.

The recognizer 110 recognizes the position and posture of the host vehicle M with respect to the traveling lane when the traveling lane is recognized. The recognizer 110 recognizes, for example, a deviation of a reference point of the host vehicle M from a center of the lane and an angle of the host vehicle M, formed with respect to a line connecting the centers of the lane in the traveling direction, as a relative position and the posture of the host vehicle M with respect to the traveling lane. Instead, the recognizer 110 may recognize the position or the like of the reference point of the host vehicle M with respect to any side end (a road dividing line or road boundary) of the traveling lane as the relative position of the host vehicle M with respect to the traveling lane.

The contact possibility determiner 120 determines whether there is a possibility of contact between the host vehicle M and an obstacle (for example, another vehicle) on the basis of the surrounding conditions (external information) recognized by the recognizer 110. For example, the contact possibility determiner 120 determines whether there is a possibility of contact between the host vehicle M and another vehicle on the basis of a contact margin value with another vehicle (a preceding vehicle) that is present in front of the host vehicle M on the basis of the surrounding conditions. The contact margin value is, for example, a value that is set on the basis of the time to collision TTC, but may also be a value that is set on the basis of a time headway THW. The time to collision TTC is derived by, for example, dividing the relative distance by the relative speed in a relationship between the host vehicle M and the other vehicle. The time headway THW is derived by, for example, dividing the relative distance (an inter-vehicle distance) by the speed of the host vehicle M. The time to collision TTC may be derived using a learned model or a predetermined function that outputs the time to collision TTC when the positions and speeds of the host vehicle M and the other vehicle are input, or may be derived using a correspondence table in which the relative speed and relative position are associated with the time to collision TTC. The derivation method described above is similar to that for the time headway THW. For example, as the time to collision TTC (or the time headway THW) is shorter, the contact margin value becomes smaller (in other words, as the time to collision is longer, the contact margin value becomes larger). For example, the contact possibility determiner 120 determines that there is a possibility that the host vehicle M and the other vehicle will come into contact when the contact margin value is less than a threshold value, and determines that there is no possibility of contact when the contact margin value is equal to or greater than the threshold value. In the following description, the time to collision TTC will be used as an example of the contact margin value.

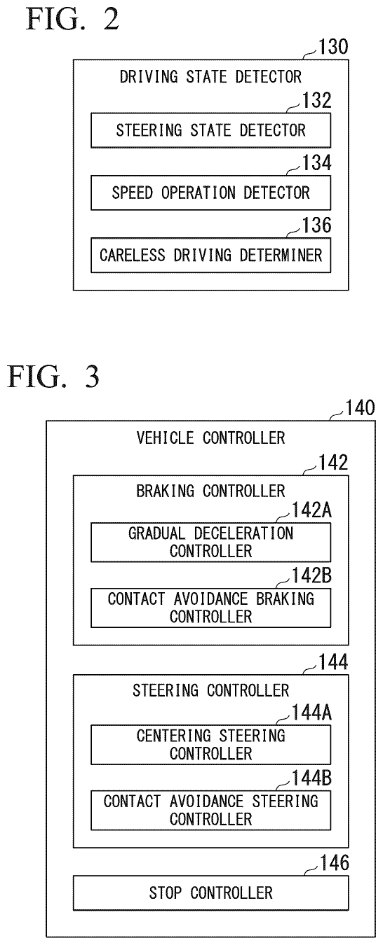

The driving state detector 130 detects the driving state of the occupant (driver) of the host vehicle M. FIG. 2 is a functional configuration diagram of the driving state detector 130. The driving state detector 130 includes, for example, a steering state detector 132, a speed operation detector 134, and a careless driving determiner 136. The steering state detector 132 detects, for example, whether the occupant is gripping the steering wheel 82, or information on the amount of operation (a steering amount (a steering input torque), a rate of change in a steering torque). The steering state detector 132 may include information on the steering speed and steering angular speed of the driver (a speed until a predetermined steering angle amount is reached). The steering state detector 132 may detect that the driver is not performing a steering operation. The steering state detector 132 performs each of the detections described above on the basis of, for example, results of the detections by the SW sensor 82A and the vehicle sensor 40, the operation of the driver obtained from the camera image of the driver monitor camera 70, and the like.

The speed operation detector 134 detects the speed operation of the driver on the basis of results of the detection by the AP sensor 84A and the BP sensor 86A, a result of the detection by the vehicle sensor 40, and the like. The speed operation includes, for example, at least one of the accelerator operation (opening) of the accelerator pedal 84 and the brake operation (opening) of the brake pedal 86. The speed operation may include at least one of the rate of change in the opening for a predetermined time due to the accelerator operation and the rate of change in the opening for a predetermined time due to the brake operation. The speed operation detector 134 may detect a state in which the driver is not performing the accelerator operation or the brake operation.

The careless driving determiner 136 determines careless driving of the driver. Careless driving is, for example, driving in a state in which a driving operation of the host vehicle M becomes slow (or is not operated) due to a decrease in an attention of the driver. For example, the careless driving determiner 136 determines that the driver is driving carelessly when a state in which the steering operation of the steering wheel 82 by the driver is below a predetermined threshold value continues for a predetermined time or more based on a result of the detection by the SW sensor 82A, and determines that the driver is not driving carelessly when the state does not continue for the predetermined time or more.

Instead of (or in addition to) the steering operation of the driver, the careless driving determiner 136 may determine that the driver is driving carelessly when a state in which the rates of change in the openings of the accelerator pedal 84 and the brake pedal 86 are less than a threshold value continues for a predetermined time or more based on results of the detection by the AP sensor 84A and the BP sensor 86A. Instead of (or in addition to) the determination described above, the driving state detector 130 may determine that the driver is driving carelessly when the state in which the state of the driver is detected not to be suitable for driving continues for a predetermined time or more, and determine that the driver is not driving carelessly when the state does not continue for the predetermined time or more. For example, the careless driving determiner 136 detects that the driver is not in a state suitable for driving on the basis of a result of an analysis of the image captured by the driver monitor camera 70 when the driver is not monitoring the vicinity (particularly the front) of the host vehicle M due to looking away or when it is predicted that concentration of the driver has decreased based on a predetermined facial expression (a sleepy face, a face in pain), or the like.

The predetermined time described above may be a fixed time or a variable time. The predetermined time may be set according to, for example, the time to collision TTC between the host vehicle M and an obstacle (for example, a preceding vehicle) in the vicinity of the host vehicle M and the speed of the host vehicle M. Specifically, the predetermined time is set shorter as the speed of the host vehicle M increases, or it is set shorter as the time to collision TTC decreases. As a result, it is possible to more appropriately determine careless driving on the basis of a situation and the surrounding conditions of the host vehicle M based on the speed of the host vehicle M and a positional relationship between the host vehicle M and the obstacle. The careless driving determination may be made comprehensively based on results of the determination according to a plurality of conditions described above.

The vehicle controller 140 controls one or both of the steering and acceleration or deceleration of the host vehicle M on the basis of the surrounding conditions recognized by the recognizer 110, and assists the driver in driving. For example, the vehicle controller 140 generates a future target trajectory so that the host vehicle M travels on a recommended lane determined by the MPU 60, and controls one or both of the steering and acceleration or deceleration of the host vehicle M on the basis of the surrounding conditions so that the host vehicle M travels along the generated target trajectory. The vehicle controller 140 may control one or both of the steering and acceleration or deceleration of the host vehicle M on the basis of a result of at least one processing performed by the contact possibility determiner 120 and the driving state detector 130. For example, when it is determined that there is a possibility of contact between the host vehicle M and an obstacle, the vehicle controller 140 generates an avoidance target trajectory for avoiding contact, and controls one or both of steering and acceleration or deceleration of the host vehicle M so that the host vehicle M travels along the generated avoidance target trajectory. The vehicle controller 140 may stop vehicle control being executed and perform control (override control) to switch to manual driving by the driver in response to a predetermined driving operation of the driver during the vehicle control. Details of processing of the vehicle controller 140 will be described below.

The HMI controller 150 notifies the occupant (including the driver) of predetermined information through the HMI 30. The predetermined information includes, for example, information related to the traveling of the host vehicle M, such as information on the state of the host vehicle M and information on driving assistance control. The information on the state of the host vehicle M includes, for example, the speed, engine speed, shift position, and the like of the host vehicle M. The information on driving control includes, for example, a type of driving assistance control being executed (for example, gradual deceleration control, centering steering control, contact avoidance braking control, contact avoidance steering control, lane maintenance steering control), a reason for operating the driving assistance control, a situation of the driving assistance control, and the like. The information on the driving assistance control may include information on paying attention and contact attention warnings for the driver. The predetermined information may include information on a current position and a destination of the host vehicle M, a remaining amount of fuel, and the like, and may also include information not related to traveling control of the host vehicle M, such as television programs, content (for example, movies) stored in a storage medium such as a DVD.

For example, the HMI controller 150 may generate an image including the predetermined information described above and display the generated image on the display 32 of the HMI 30, or may generate a sound indicating the predetermined information and output the generated sound from the speaker 34 of the HMI 30. A timing at which the sound is output may be, for example, a timing at which driving control is started or stopped, a timing at which the image to be displayed is switched, or a timing at which the host vehicle M is in a predetermined state. The HMI controller 150 may output information received by the HMI 30 to the vehicle controller 140, and the like.

### Vehicle Controller

Next, the vehicle controller 140 will be described in detail. FIG. 3 is a functional configuration diagram of the vehicle controller 140. The vehicle controller 140 includes, for example, a braking controller 142, a steering controller 144, and a stop controller 146. For example, the vehicle controller 140 performs warning control and avoidance control to avoid contact between the host vehicle M and an obstacle through control by the braking controller 142 and the steering controller 144. The warning control is control that is operated when the host vehicle M approaches an obstacle, and includes, for example, gradual deceleration control, centering steering control, and the like which will be described below. The avoidance control is control that is operated when the host vehicle M approaches an obstacle more closely than when the warning control is operated, and includes, for example, contact avoidance braking control and contact avoidance steering control, which will be described below. These types of control are examples of the driving assistance control that assists the driver in driving.

When it is determined that an obstacle is present in front of the host vehicle M on the basis of a result of the recognition by the recognizer 110, the braking controller 142 performs braking control on the host vehicle M on the basis of a target deceleration of the host vehicle M. For example, the braking controller 142 sets a deceleration state on the basis of the time to collision (TTC) between the host vehicle M and an obstacle, and executes deceleration control based on the set deceleration state. The braking controller 142 includes, for example, a gradual deceleration controller 142A and a contact avoidance braking controller 142B.

The gradual deceleration controller 142A performs gradual deceleration control on the host vehicle M when the recognizer 110 determines that an obstacle (for example, another vehicle) is present in front of the host vehicle M. The gradual deceleration control is control (attention calling control) for notifying the driver that an obstacle is approaching by a vehicle behavior such as deceleration (change in longitudinal G) and prompting the driver to pay attention to the obstacle, and is control that is different from contact avoidance control for avoiding contact with the obstacle (however, there may be cases where the driver avoids contact with the obstacle as a result). For example, when it is determined that an obstacle is present in front of the host vehicle M, the gradual deceleration controller 142A derives a target deceleration of the host vehicle M, and decelerates the host vehicle M to approach the derived target deceleration without an operation of the driver. For example, the gradual deceleration controller 142A generates a target trajectory including speed information, and performs deceleration control on the host vehicle M so that the host vehicle M travels along the generated target trajectory. The gradual deceleration control may be executed when the driving state detector 130 detects that the driver is driving carelessly, or may be executed when the contact margin value satisfies an operating condition of the gradual deceleration control.

The contact avoidance braking controller 142B performs emergency brake control to avoid contact between the host vehicle M and an obstacle. For example, when the contact possibility determiner 120 determines that there is a possibility of contact between the host vehicle M and an obstacle, the contact avoidance braking controller 142B performs braking control (deceleration control) to avoid contact. The braking control performed by the contact avoidance braking controller 142B includes, for example, a collision mitigation brake system (CMBS) control that assists with contact avoidance or damage mitigation. For example, the contact avoidance braking controller 142B generates a target trajectory including speed information, and performs deceleration control on the host vehicle M so that the host vehicle M travels along the generated target trajectory. The braking control performed by the contact avoidance braking controller 142B may be executed, for example, after the gradual deceleration control, or may be executed when the contact margin value satisfies an operating condition of the contact avoidance braking control.

The steering controller 144 controls the steering of the host vehicle M. The steering controller 144 includes, for example, a centering steering controller 144A and a contact avoidance steering controller 144B.

When the recognizer 110 determines that an obstacle is present in front of the host vehicle M, the centering steering controller 144A generates a target trajectory for moving the host vehicle M toward a center of the traveling lane, and executes steering control (centering steering control) so that the host vehicle M travels along the generated target trajectory. This steering control is control which is not intended to avoid contact with the obstacle, but is intended to notify the driver that an obstacle is approaching according to the vehicle behavior (a change in lateral G) that moves laterally toward the center, and to prompt the driver to pay attention to the obstacle (however, there may be cases where the driver avoids contact with the obstacle as a result). This steering control can make the driver aware of an obstacle ahead at an early stage, and contribute to driving to avoid contact. The centering steering control may be executed when the driving state detector 130 detects that the driver is driving carelessly, or when the contact margin value satisfies an operation condition of the steering control. The gradual deceleration control and centering steering control described above may be executed separately, or may be executed simultaneously at the same timing (for example, in an attention calling control stage).

When the contact possibility determiner 120 determines that there is a possibility of contact between the host vehicle M and an obstacle, the contact avoidance steering controller 144B generates a target trajectory (an avoidance target trajectory) for avoiding contact, and executes steering control related to the avoidance steering assistance so that the host vehicle M travels along the generated target trajectory. For example, when an avoidance is possible within the travel lane of the host vehicle M, the contact avoidance steering controller 144B performs steering control to move the host vehicle in a direction not to contact an obstacle within a range not departing from the same lane, without a steering operation of the driver. The contact avoidance steering controller 144B may perform steering control on the host vehicle M so that a behavior of the host vehicle M after the avoidance operation for an obstacle is stabilized after the avoidance operation is performed by the host vehicle M crossing a dividing line that divides the traveling lane, using the steering operation of the driver (for example, a steering amount equal to or greater than a first threshold value) as a trigger (driver steering trigger). In the steering control of the contact avoidance steering controller 144B, for example, feedforward control or feedback control is performed as needed on the basis of the avoidance target trajectory and the position of the host vehicle M to adjust a steering angle of the host vehicle M. The steering control executed by the contact avoidance steering controller 144B may be executed, for example, after the centering steering control, or when the contact margin value satisfies the operation condition of the steering control.

The stop controller 146 determines whether to execute the stop control (override determination) according to a driving operation of the driver (an operation of the driver) while the braking control described above (the gradual deceleration control or the contact avoidance braking control) or the steering control (the centering steering control or the contact avoidance steering control) is executed. When it is determined that the stop control needs to be executed, the stop controller 146 executes the stop control (override control) that stops the braking control or steering control that is being executed and switches it to manual driving by the driver.

For example, the stop controller 146 performs an override determination on the basis of content of the accelerator operation or brake operation of the driver detected by the driving state detector 130. In this case, the stop controller 146 determines to execute the stop control when, for example, during the braking control or steering control, an amount of accelerator operation of the driver (an opening of the accelerator pedal 84 detected by the AP sensor 84A) or an amount of brake operation (an opening of the brake pedal 86 detected by the BP sensor 86A) is equal to or greater than a speed override threshold value. Instead of (or in addition to) the amounts of operations described above, the stop controller 146 may determine to execute the stop control when the rate of change in the opening is equal to or greater than the speed override threshold value. The speed override threshold value is an example of a “second threshold value.” The second threshold value is a threshold value for the opening or a threshold value for the rate of change in the opening depending on an object to be determined.

The stop controller 146 may perform an override determination on the basis of content of the steering operation of the driver using the steering wheel 82. For example, during the braking control or steering control, the stop controller 146 determines to perform override control when a steering input torque due to the steering operation of the driver is equal to or greater than the steering override threshold value. The steering override threshold value is a value greater than the first threshold value (the driver steering trigger).

In addition to the vehicle control described above, the vehicle controller 140 may execute steering control related to lane keeping steering assistance, for example, as lane keeping assistance system (LKAS) control (lane keeping control) so that the host vehicle M is kept in the traveling lane (in other words, so that the host vehicle M is suppressed from deviating from the traveling lane). For example, in the lane keeping control, the vehicle controller 140 controls the steering device 220 so that the host vehicle M does not deviate from the traveling lane recognized by the recognizer 110, thereby assisting the driver in the steering operation. In this case, the vehicle controller 140 generates a target trajectory (a lane keeping target trajectory) so that the host vehicle M travels in the center of the traveling lane, and executes the steering control of the host vehicle M so that the host vehicle M travels along the generated target trajectory. In the steering control by the vehicle controller 140, for example, feedforward control or feedback control is performed as needed on the basis of the lane keeping target trajectory and the position of the host vehicle M to adjust the steering angle of the host vehicle M. The vehicle controller 140 may execute similar control in a case of road departure mitigation (RDM) control instead of LKAS control.

### Vehicle Control Related to Contact Avoidance

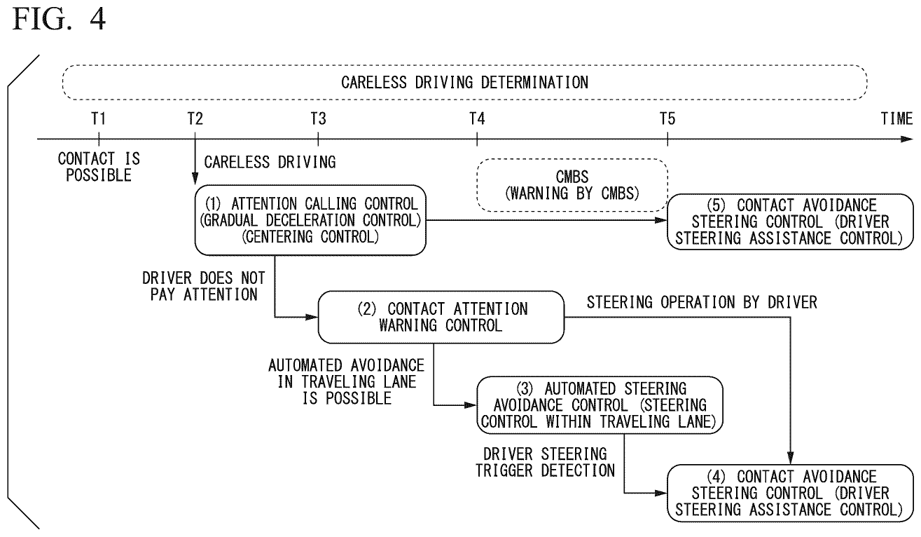

Next, content of vehicle control related to contact avoidance in the embodiment will be specifically described. In the following description, it is assumed that the obstacle is another vehicle (a preceding vehicle) traveling in front of the host vehicle M. FIG. 4 is a diagram for describing the content of vehicle control related to contact avoidance. In the example of FIG. 4, the content of vehicle control when it is determined that there is a possibility of contact based on the time to collision (TTC) is shown. In the example of FIG. 4, it is assumed that a time T1 is the earliest, followed by times T2, T3, T4, and T5 in that order. In the example of FIG. 4, it is assumed that the driving state detector 130 has continuously determined whether the host vehicle is driving carelessly at a predetermined cycle since a stage prior to the time T1.

First, at the time T1, it is assumed that the contact possibility determiner 120 has determined that there is a possibility of contact between the host vehicle M and another vehicle. When it is determined that there is a possibility of contact, the vehicle controller 140 performs attention calling control ((1) in FIG. 4) to prompt the driver to pay attention to the surroundings (particularly in the traveling direction) on the basis of the time to collision (TTC) and a result of the careless driving determination.

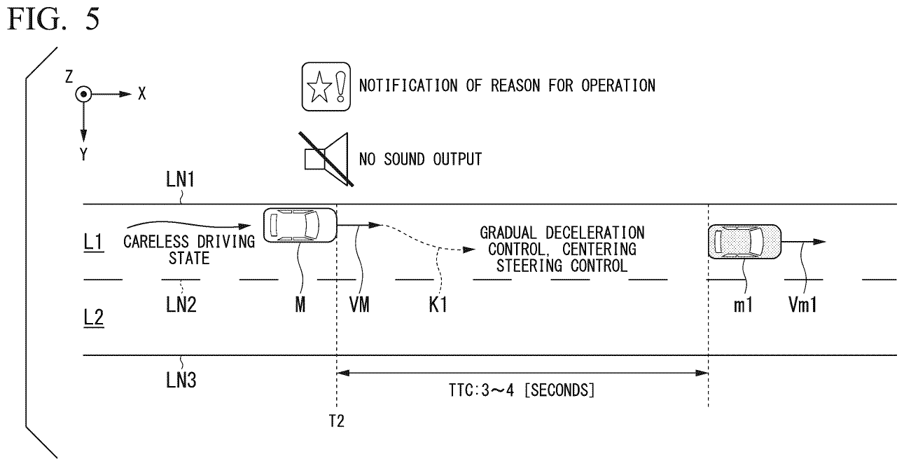

FIG. 5 is a diagram for describing content of attention calling control. In the example of FIG. 5, two lanes L1 and L2 that can travel in the same direction (an X-axis direction in FIG. 5) are shown. A lane L1 is divided by road dividing lines LN1 and LN2, and a lane L2 is divided by road dividing lines LN2 and LN3. In the example of FIG. 5, it is assumed that the host vehicle M is traveling on the lane L1 at a speed VM, and another vehicle ml is present in front of the host vehicle M and is traveling on the lane L1 at a speed of Vm1.

In the example of FIG. 5, the vehicle controller 140 performs the attention calling control when it is a time T2 at which the time to collision TTC based on a relative position and a relative speed between the host vehicle M and the other vehicle ml becomes less than a first predetermined time, and it is determined that the driver is performing careless driving. The time T2 is, for example, a time at which the time to collision TTC becomes about 3 to 4 [seconds].

The attention calling control includes, for example, at least one of the gradual deceleration control and the centering steering control. The gradual deceleration control executed in the attention calling control is control in a first deceleration state. The gradual deceleration controller 142A sets a target deceleration (a first target deceleration) so that a load (longitudinal G) of a first upper limit deceleration (about 0.1 G) is applied to the driver in the traveling direction (longitudinal direction). In the attention calling control (the first deceleration state), the gradual deceleration controller 142A may first perform gradual deceleration control at a first deceleration rate (for example, 0.05 [G] of the longitudinal G), and then perform deceleration control at a second deceleration rate (for example, 0.1 [G] of the longitudinal G) that is greater than the first deceleration rate. By controlling the deceleration rate so that it increases in stages in this manner, it is possible to reduce the load on the occupants, such as the driver, at a start of the gradual deceleration control, and to suppress the occupants from being surprised by the gradual deceleration control.

In the attention calling control shown in FIG. 5, the centering steering controller 144A performs centering steering control for steering the host vehicle M so that a reference point, such as the center of gravity or center, of the host vehicle M is positioned in the center of the traveling lane (the lane L1) on the basis of a result of the recognition by the recognizer 110, map information, and the like. In the example of FIG. 5, the vehicle controller 140 generates a future target trajectory K1 of the host vehicle M corresponding to the gradual deceleration control and the centering steering control, and controls the steering and speed of the host vehicle M so that the host vehicle M travels along the generated target trajectory K1.

At a time T2, the HMI controller 150 may generate an image including information indicating a reason for operating the attention calling control (the gradual deceleration control and the centering steering control) for the driver, and may notify the driver by displaying the generated image on the display 32. The image may include information for prompting the driver to pay attention. However, in this case, a sound output may not be performed. As a result, it is possible to easily inform the driver that the host vehicle M is approaching another vehicle ml to prompt the driver to pay attention, and to prompt the driver to perform an early avoidance operation.

Returning to FIG. 4, when the driver does not respond to an attention call (or the override control) even after the attention calling control described above is performed, the contact attention warning control ((2) in FIG. 4) is performed when it reaches a time T3 at which the time to collision (TTC) is less than a second predetermined time (a second predetermined time is shorter than the first predetermined time), and the driver is determined to be driving carelessly. Whether the driver responds to the attention call is determined on the basis of, for example, a camera image captured by the driver monitor camera 70. The time T3 is, for example, a time when the time to collision (TTC) is about 2 [seconds].

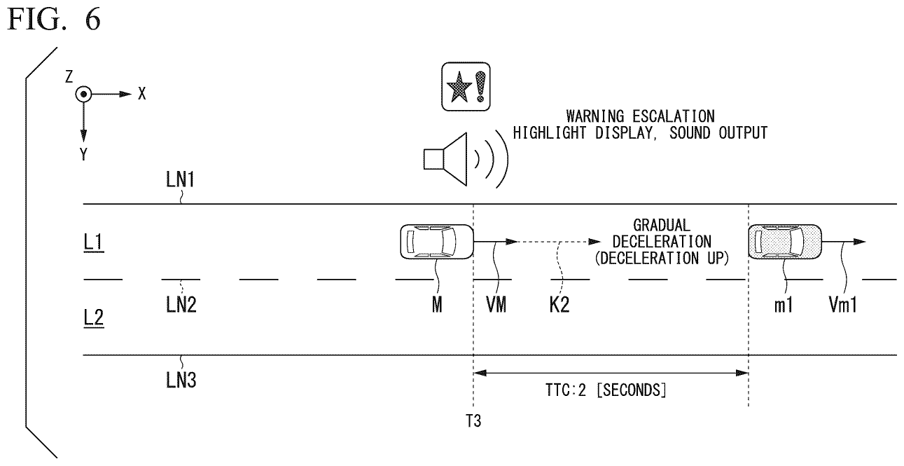

FIG. 6 is a diagram for describing content of the contact attention warning control. FIG. 6 shows a scene in which the time to collision (TTC) is 2 seconds without the driver performing an accelerator operation, from the situation shown in FIG. 5. In a contact attention warning control stage, the gradual deceleration controller 142A sets a target deceleration (a second target deceleration), executes the gradual deceleration control according to the set second target deceleration, generates a target trajectory K2, and performs control so that the host vehicle M travels along the generated target trajectory K2. The gradual deceleration control executed in the contact attention warning control is control in the second deceleration state. In the second deceleration state, the gradual deceleration controller 142A sets a target deceleration (the second target deceleration) so that a load (longitudinal G) greater than the first upper limit deceleration is applied to the driver in the traveling direction (longitudinal direction) at or below a second upper limit deceleration (about 0.2 [G]). As a result, it is possible to make the driver more clearly aware that the host vehicle M is approaching the other vehicle m1. In this manner, since the deceleration control is performed while increasing the deceleration as needed, it is possible to create more time to make the driver aware of the other vehicle m1, and the driver can perform a drive to avoid contact with the other vehicle ml with plenty of time.

During contact attention warning control, in addition to (or instead of) the gradual deceleration control, the centering steering control may be executed by the centering steering controller 144A. During the contact attention warning control, the HMI controller 150 may execute control (warning escalation control) to highlight an image of attention calling information displayed on the display 32 or to output a warning to the speaker 34. As a result, it is possible to notify the driver of a high possibility of contact by an image and a sound while causing the host vehicle to further decelerate, and to more clearly prompt the driver to pay attention and perform the contact avoidance control. The attention calling control and contact attention warning control described above are control executed as “warning control.”

Returning to FIG. 4, after the contact attention warning control is executed, the vehicle controller 140 executes automated steering avoidance control at a time T4 at which it is determined that automated avoidance is possible in the traveling lane based on the surrounding conditions recognized by the recognizer 110 ((3) in FIG. 4). The time T4 is a time at which the host vehicle M is closer to the other vehicle m1 than the time T3 (for example, the time to collision TTC is less than about 2 [seconds]).

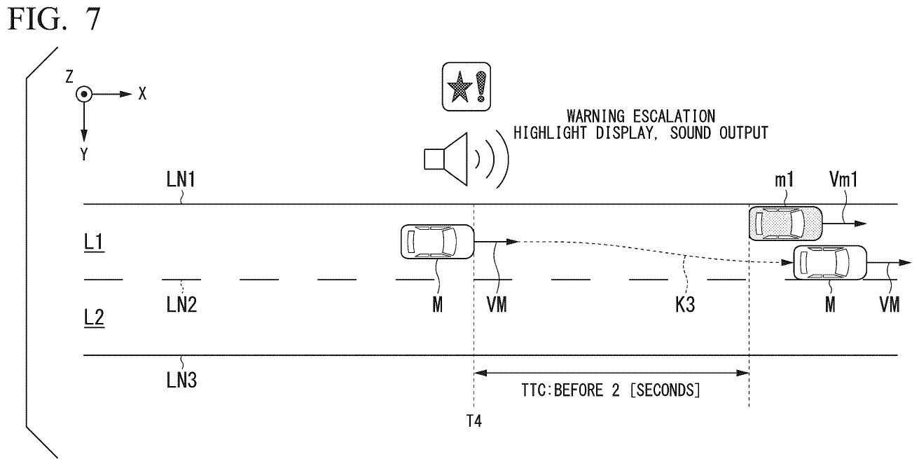

FIG. 7 is a diagram for describing content of automated steering avoidance control. The example of FIG. 7 shows control when the driver does not perform a predetermined accelerator operation after the contact attention warning control is executed. In this case, the contact avoidance steering controller 144B recognizes an area of the traveling lane (the lane L1) and a position of the other vehicle ml based on a result of the recognition by the recognizer 110, and when an avoidance space is present in the traveling lane, generates an avoidance target trajectory K3 for traveling through the avoidance space, and performs steering control so that the host vehicle M travels along the generated avoidance target trajectory K3. In this case, acceleration or deceleration control may be performed by the vehicle controller 140 as necessary. During the automated steering avoidance control, the HMI controller 150 may continue to execute the warning escalation control described above. As a result, it is possible to realize more appropriate vehicle control by executing automated steering control when steering avoidance is possible with highly safe control.

The vehicle controller 140 may execute CMBS control in parallel with the contact avoidance braking controller 142B at a timing of the time T4. When the CMBS control is executed, the automated steering avoidance control described above or the driver steering assistance control to be described below may not be executed. In this case, the HMI controller 150 may output a warning (an image or a sound) related to the CMBS control.

Returning to FIG. 4, at a time T5 when the driver operates the steering wheel 82 (detects the driver steering trigger) and performs a steering operation in a direction to avoid the other vehicle m1, the contact avoidance steering controller 144B executes contact avoidance steering control (driver steering assistance (one example of the avoidance steering assistance)) to prevent the host vehicle from further deviating from an adjacent lane (the lane L2) adjacent to the traveling lane (the lane L1) ((4) in FIG. 4). The driver steering trigger here is, for example, that the steering input torque by the driver to avoid the other vehicle m1 is equal to or greater than the first threshold value (and less than the steering override threshold value). The driver steering assistance control may be executed after the automated steering avoidance control, or may also be executed after the contact attention warning control (at a timing of the time T4 without executing the automated steering avoidance control).

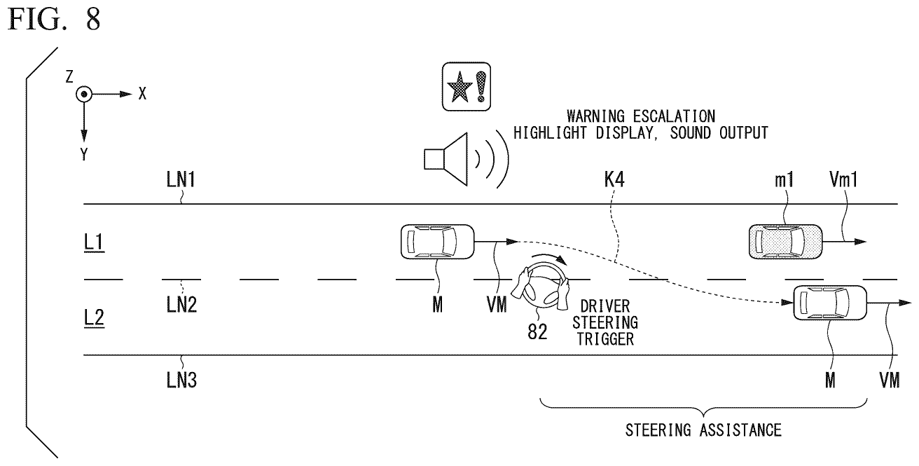

FIG. 8 is a diagram for describing steering control after the driver steering trigger. In the example of FIG. 8, when the host vehicle M is about to come into contact with the other vehicle m1 and the driver steering trigger is detected, the contact avoidance steering controller 144B allows the host vehicle M to move from the lane L1 to the adjacent lane L2, and performs the steering control on the host vehicle M so that the host vehicle M does not deviate further from the adjacent lane L2. In this case, the contact avoidance steering controller 144B generates an avoidance target trajectory K4 that changes lanes to the lane L2, and controls the steering of the host vehicle M so that the position of the host vehicle M approaches the avoidance target trajectory K4 through a steering operation by the driver, thereby executing the avoidance steering assistance. In this case, the contact avoidance steering controller 144B may perform control so that the steering input torque amount is suppressed by applying a reaction force to the steering wheel 82 in response to the steering operation of the driver, instead of (or in addition to) the steering control. During the driver steering assistance, the HMI controller 150 may continue to execute the warning escalation control described above. As a result, it is possible to realize more appropriate vehicle control even when emergency avoidance steering is performed by the steering operation of the driver.

Returning to FIG. 4, when the time to collision TTC approaches a limit value after the attention calling control shown in (1) of FIG. 4 and the driver performs a steering operation, the vehicle controller 140 executes the driver steering assistance so as not to cross the adjacent lane ((5) of FIG. 4), similar to the control in (4) of FIG. 4. In this case, the HMI controller 150 may perform notification control such as a notification or a warning indicating that the driver steering assistance control is operating. The contact avoidance braking control and contact avoidance steering control described above are control executed as “avoidance control.”

### Suppression of Stop Control

For example, in the driver steering assistance control shown in (4) and (5) of FIG. 4, when the steering controller 144 (the vehicle system) executes steering (a steering angle) control to move the host vehicle M closer to the avoidance target trajectory K4 during the driver steering assistance (and when the override control is not being executed), the posture of the driver may be disturbed due to a change in the behavior of the host vehicle M (especially lateral movement). In this case, the driver may unintentionally operate the accelerator pedal 84 or brake pedal 86 due to the disturbed posture, which may result in the execution of the stop control by the stop controller 146. For this reason, in the embodiment, the stop controller 146 suppresses the execution of the stop control to stop the driver steering assistance control when a predetermined condition is satisfied during the driver steering assistance.

For example, as a first predetermined condition, when the driver performs a speed operation (for example, an accelerator operation) within a predetermined time after a start of the driver steering assistance, the stop controller 146 suppresses execution of the stop control (makes it difficult to execute the stop control) even when the driver performs an accelerator operation equal to or greater than the speed override threshold value.

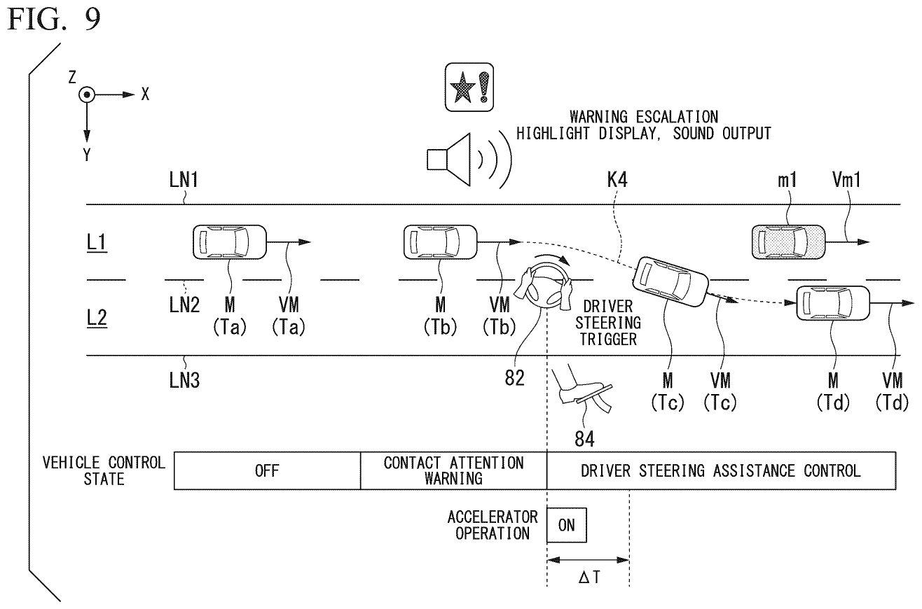

FIG. 9 is a diagram for describing the driver steering assistance and stop control executed by the vehicle controller 140. In the example of FIG. 9, the behavior of the host vehicle M before and after the start of the driver steering assistance control, a vehicle control state, and an accelerator operation state of the driver with respect to the accelerator pedal 84 are shown. In the example of FIG. 9, a time Ta is the earliest, followed by times Tb, Tc, and Td in that order. In the example of FIG. 9, the position and speed VM of the host vehicle M at a time T* are represented as M(t*) and VM(t*).

At the time Ta, the vehicle control of the host vehicle M is in an off state. At this time, control such as LKAS may be executed on the host vehicle M, for example, in response to an instruction from the driver (an instruction to execute driving assistance using a changeover switch, or the like). At the time Tb, the host vehicle M satisfies execution conditions for the contact attention warning shown in (2) of FIG. 4, so that the contact attention warning control is executed. After that, the vehicle controller 140 starts the driver steering assistance control when it detects the driver steering trigger, and executes the driver steering assistance (avoidance steering assistance) control so that the host vehicle M travels along the avoidance target trajectory K4.

Here, immediately after the driver steering assistance control is started, there is a high possibility that the posture of the driver will be disturbed due to a change in the behavior of the host vehicle M that is not intended by the driver, as described above. For this reason, for example, the vehicle controller 140 suppresses the execution of the stop control even when the accelerator operation is equal to or greater than the override threshold value until a predetermined time ΔT has elapsed since the start of the driver steering assistance control. The predetermined time ΔT may be, for example, a fixed time determined in advance, or may be a variable time according to the traveling situation of the host vehicle M (for example, a positional relationship (relative position) between the host vehicle M and an obstacle (the other vehicles m1) in the vicinity or the speed VM of the host vehicle M) and surrounding conditions (for example, a road shape and a width of the traveling lane).

Suppressing the execution of the stop control includes, for example, making the speed override threshold value (the second threshold value) larger than the speed override threshold value under normal circumstances by a predetermined amount to make it difficult to execute the stop control. The normal circumstances here are when the execution of the stop control is not suppressed, and are, for example, a time period before or after the predetermined time ΔT (in the example of FIG. 9, during the contact attention warning control or during the driver operation assistance control after the predetermined time ΔT has elapsed). The predetermined amount may be, for example, a fixed amount determined in advance, or may be a variable amount according to the traveling situation and surrounding conditions of the host vehicle M.

In the example of FIG. 9, the driver performs an accelerator operation equal to or greater than the speed override threshold value until the predetermined time ΔT has elapsed since the start of the driver steering assistance control by the driver steering trigger (the accelerator operation is in an “ON” state shown in FIG. 9), but the stop control is not executed for the accelerator operation during this period, and the driver steering assistance control continues to be executed at times Tc and Td.

When an accelerator operation equal to greater than the speed override threshold value, which is larger than that under normal circumstances by a predetermined amount, is detected until the predetermined time ΔT has elapsed, the stop controller 146 executes the stop control. As a result, it is difficult to execute the stop condition by making the execution conditions of stop control stricter, but it is possible to prevent the stop control from being completely unable to be executed.

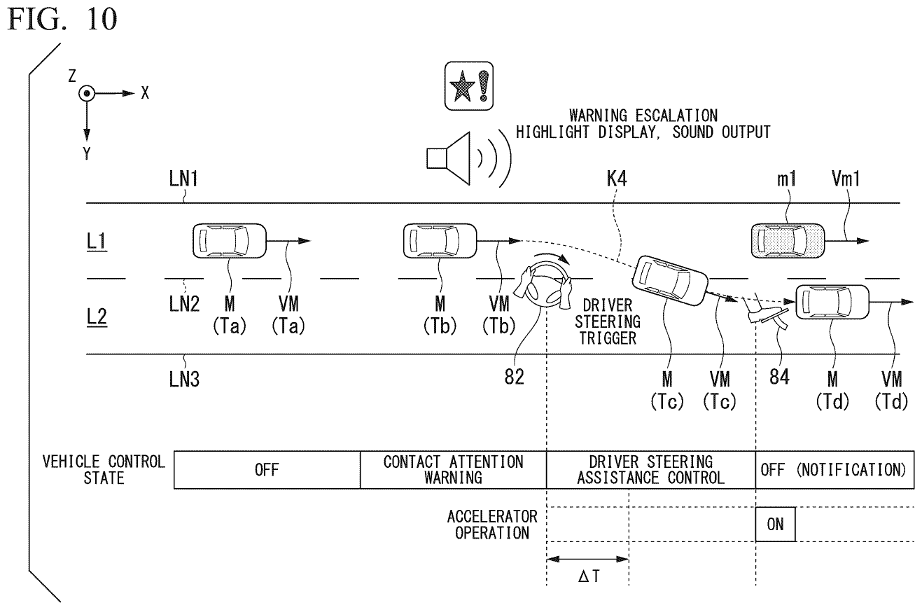

FIG. 10 is a diagram for describing vehicle control when an accelerator operation is executed after the predetermined time ΔT has elapsed since the start of the driver steering assistance control. The example of FIG. 10 differs from that of FIG. 9 in that the accelerator operation is executed at a timing after the predetermined time ΔT. As shown in FIG. 10, when an accelerator operation that is equal to or greater than the speed override threshold value is executed at a timing after the predetermined time ΔT (and while the driver steering assistance control is being executed), the stop controller 146 executes the stop control related to the driver steering assistance control being executed. Therefore, at a time Td shown in FIG. 10, the vehicle control state is in the OFF state, and the host vehicle M travels under manual driving by the driver. When the driver steering assistance control is stopped by the stop control, the HMI controller 150 may notify the driver by causing the HMI 30 to output information indicating that the control has been stopped. As a result, it is possible to allow the driver to ascertain that the driver steering assistance control has been stopped on its way due to accelerator steering, and make the driver aware of appropriate driving.

As described above, by suppressing the execution of the stop control until a predetermined time ΔT has elapsed since the start of the execution of the driver steering assistance control, it is possible to suppress the driver steering assistance control from being stopped (or being switched to manual driving) due to an accelerator operation that the driver does not intend (due to disturbed posture). Therefore, more appropriate driving assistance control can be performed in a situation of avoiding contact with an obstacle.

Instead of (or in addition to) the first predetermined condition described above, the stop controller 146 may suppress the execution of the stop control related to the driver steering assistance control as a second predetermined condition when a steering amount of the steering operation of the driver during the driver steering assistance control is equal to or greater than a third threshold value that is greater than the first threshold value. The steering amount is acquired, for example, on the basis of a result of the detection by the SW sensor 82A or a result of the detection by the steering state detector 132. The third threshold value is a value less than the steering override threshold value. When the posture of the driver is disturbed due to a change in the behavior of the host vehicle M during the driver steering assistance, the driver may perform an unintended steering operation due to the disturbed posture. For this reason, when the steering amount equal to or greater than the third threshold value, which is greater than the first threshold value that serves as the determination condition for the driver steering trigger as described above, is detected, the execution of the stop control related to the accelerator operation of the driver is suppressed. As a result, it is possible to perform more appropriate driving assistance control, as described above.

The stop controller 146 may not execute the stop control even when the steering amount of the steering operation of the driver is equal to or greater than the steering override threshold value until a predetermined time ΔT has elapsed since the start of the driver steering assistance control.

The stop controller 146 may use the steering speed instead of the steering amount of the steering operation described above to determine whether to suppress the execution of the stop control. When the posture of the driver is disturbed, there is a high possibility that a faster steering operation will be performed than during normal driving. For this reason, the stop controller 146 suppresses the execution of the stop control when the steering speed during the driver steering assistance control is equal to or higher than a predetermined speed.

The accelerator operation by the driver includes an opening of an accelerator. The accelerator operation by the driver may also include the rate of change in the opening of the accelerator. When there is a high possibility that the posture of the driver will be disturbed, the override threshold value is suppressed, and when the driver intends to override, he or she can perform an override. The stop controller 146 may use the opening of the accelerator and the rate of change in the opening of the accelerator as an accelerator operation threshold value. As a result, it is possible to more appropriately determine whether to execute override control using a more detailed accelerator operation by the driver.

Instead of (or in addition to) suppressing the execution of the stop control by increasing the speed override threshold value more than that under normal circumstances when the predetermined condition is satisfied, the stop controller 146 may suppress the execution of the stop control by limiting an object to be determined. For example, when the amount of accelerator operation (the opening of the accelerator pedal) or the rate of change in the opening is used as the object to be determined under normal circumstances, the stop controller 146 does not execute the determination using the rate of change in the opening when the stop control is suppressed. When the posture of the driver is disturbed, there is a high possibility that the rate of change in the opening will change suddenly, so that, by invalidating the override determination based on the rate of change in the opening when the stop control is suppressed, it is possible to more appropriately suppress the driver from unintentionally executing the stop control.

The stop controller 146 may perform control not to execute the stop control temporarily (for example, until the predetermined time ΔT has elapsed since the start of the driver steering assistance control) when the predetermined condition is satisfied during the execution of the driver steering assistance control. In a situation where the posture of the driver is likely to be disturbed, by completely invalidating the stop control, it is possible to perform control that is easy for the driver to understand regardless of the amount of accelerator operation. In this case, the HMI controller 150 may output information indicating that the stop control cannot be temporarily executed to the HMI 30 to notify the driver of it. As a result, it is possible to allow the driver to ascertain that the stop control cannot be temporarily executed, and to make the driver aware of appropriate driving. In the embodiment, “suppressing the execution of the stop control” may include “not executing the stop control.”

### Processing Flow

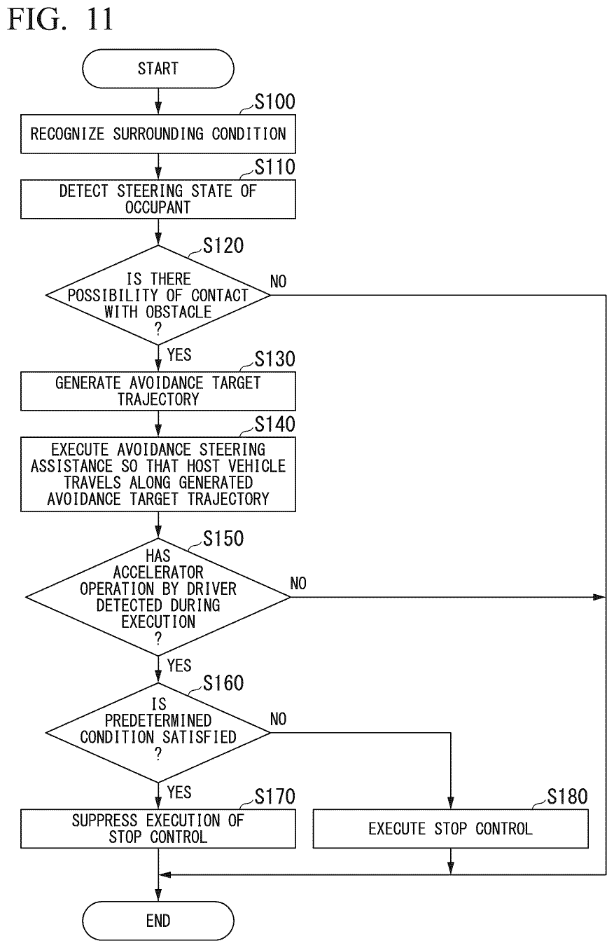

FIG. 11 is a flowchart which shows an example of processing executed by the driving assistance device 100 in the embodiment. In the example of FIG. 11, processing of suppressing the stop control during the driver steering assistance, among processing executed by the driving assistance device 100, will be mainly described. In addition to the processing shown in FIG. 11, the driving assistance device 100 can execute contact possibility determination processing, careless driving determination processing, attention calling control processing, contact attention warning control processing, automated steering avoidance control processing, and the like, as shown in FIG. 4, depending on the execution conditions described above. The processing shown in FIG. 11 may be executed repeatedly at a predetermined timing.

In the example of FIG. 11, the recognizer 110 recognizes the surrounding conditions of the host vehicle M (step S100). Next, the driving state detector 130 detects the steering state of the driver (step S110). Next, the contact possibility determiner 120 determines whether there is a possibility that the host vehicle M will come into contact with an obstacle (step S120). When it is determined that there is a possibility of contact with the obstacle, the contact avoidance steering controller 144B generates an avoidance target trajectory for the host vehicle M to avoid contact with the obstacle (step S130), and executes avoidance steering assistance so that the host vehicle M travels along the generated avoidance target trajectory (step S140). The avoidance steering assistance according to the processing in step S140 is, for example, driver steering assistance control executed in response to a detection of a driver steering trigger.

Next, the stop controller 146 determines whether a steering operation by the driver has been detected during the execution of the avoidance steering assistance (step S150). When it is determined that steering by the driver has been detected during the execution, the stop controller 146 determines whether the conditions related to the accelerator operation satisfy a predetermined condition (step S160). When it is determined that the predetermined condition is satisfied, the stop controller 146 suppresses the execution of the stop control (step S170). When it is determined that the predetermined condition is not satisfied, the stop controller 146 executes the stop control (step S180). As a result, the processing of this flowchart will end.

When it is determined in the processing of step S120 that there is no possibility of contact with the obstacle, or when it is determined in the processing of step S150 that the accelerator operation of the driver is not detected during the execution of the avoidance steering assistance, the processing of this flowchart will end.

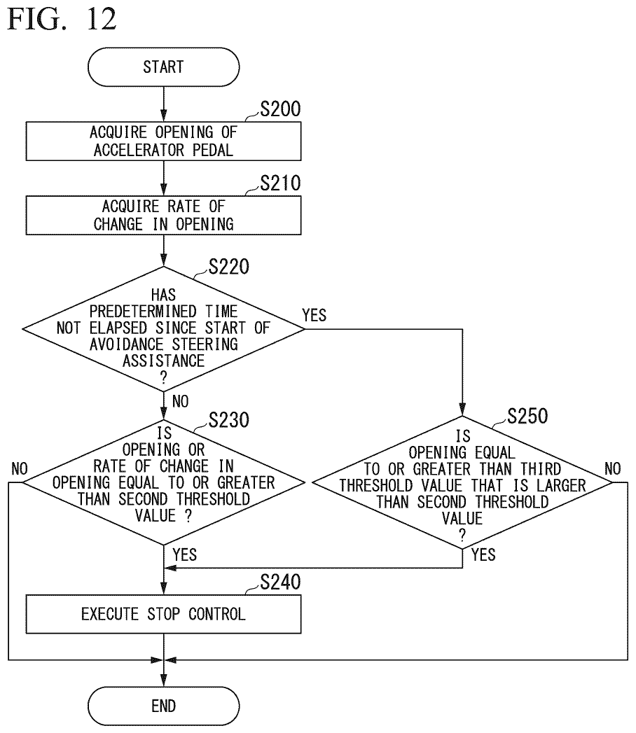

FIG. 12 is a flowchart which shows an example of stop control processing. The example of FIG. 12 shows processing in which the stop control is suppressed by adjusting a determination condition for whether to execute the stop control on the basis of whether the predetermined condition is satisfied after the avoidance steering assistance control is started. The processing shown in FIG. 12 may be executed repeatedly at a predetermined timing while the avoidance steering assistance control is being executed.

In the example of FIG. 12, the stop controller 146 acquires the opening of the accelerator pedal 84 of the driver using the speed operation detector 134 (step S200), and acquires the rate of change in the opening at a predetermined time (step S210). Next, the stop controller 146 determines whether a predetermined time has not elapsed since the start of the avoidance steering assistance, as the predetermined condition (step S220). When it is determined that the predetermined time has not elapsed (that is, when it is determined that the predetermined condition is not satisfied), the stop controller 146 determines whether the opening or the rate of change in the opening is equal to or greater than a second threshold value (a speed override threshold value) (step S230). When the stop controller 146 determines that the opening or the rate of change in the opening is equal to or greater than the second threshold value, it executes the stop control (step S240), and when it determines that the opening or the rate of change in the opening is less than the second threshold value, it ends the processing without executing the stop control.

When it is determined in the processing of step S220 that a predetermined time has not elapsed since the start of the avoidance steering assistance (that is, when it is determined that the predetermined condition is satisfied), by setting only the opening as a target, it is further determined whether the opening is equal to or greater than a threshold value that is greater than the second threshold value (step S250). When the stop controller 146 determines that the opening is equal to or greater than the threshold value that is greater than the second threshold value, it executes the stop control (step S240), and when it is less than the threshold value, it ends the processing without executing the stop control. As a result, the processing of this flowchart will end.

In the processing of FIG. 12, no override determination based on the rate of change in the opening of the accelerator pedal is performed until a predetermined time has elapsed since the start of the avoidance steering assistance. Furthermore, in the processing of step S250, a threshold value for determining whether to execute the stop control is set to be greater than the second threshold value in the processing of step S230. By making the conditions for executing the stop control strict in this manner, it is possible to suppress the execution of the stop control.

As described above, according to the embodiment, a vehicle control program causes a computer to recognize surrounding conditions of the host vehicle M, detect a steering state of a driver (an example of an occupant) of the host vehicle, detect a speed operation of the host vehicle by the driver, determine that there is a possibility of contact between the host vehicle and an obstacle on the basis of the recognized surrounding conditions of the host vehicle, execute avoidance steering assistance to avoid contact with the obstacle when a steering amount equal to or greater than a first threshold value is detected from the steering state of the driver, execute the stop control to stop the avoidance steering assistance when a speed operation equal to or greater than a second threshold value is detected from the detected speed operation during the execution of the avoidance steering assistance, and perform more appropriate driving assistance control on the driver in a situation of avoiding contact with an obstacle by suppressing the execution of the stop control when the predetermined condition is satisfied during the execution of the avoidance steering assistance.

According to the embodiment, for example, when the avoidance steering assistance is started (initial stage), the posture of the driver is likely to be disturbed, so that an override threshold value is set stricter than that under normal circumstances to suppress the execution of the stop control, thereby suppressing the execution of an override due to an accelerator operation that the driver does not intend. According to the embodiment, when the steering amount during the avoidance steering assistance is equal to or greater than a third threshold value, the posture of the driver is likely to be disturbed, so that it is possible to suppress the override (stop control) due to an accelerator operation that the driver does not intend by suppressing the execution of the stop control.

### Modified Example

In the embodiment described above, when the host vehicle M moves from a traveling lane (the lane L1) to an adjacent lane (the lane L2) as shown in FIG. 8, in addition to (or instead of) the steering control being executed so as not to deviate from the lane L2, the driver steering assistance control may perform contact avoidance steering control in the traveling lane (the lane L1). In this case, the driver steering assistance control generates an avoidance target trajectory to avoid contact with an obstacle and not to deviate from the traveling lane, and avoidance steering assistance is executed so that the host vehicle M travels along the generated avoidance target trajectory. When the steering operation of the driver is detected during this steering control, the avoidance steering assistance is suppressed.

In the embodiment, in addition to (or instead of) the driver steering assistance control, the steering controller 144 may execute suppression control of the stop control described above when the steering operation or speed of the driver is detected (and the override control is not executed) during, for example, the automated steering avoidance control as shown in FIG. 7.

In the embodiment, instead of (or in addition to) the predetermined condition described above, it may be determined whether the posture of the driver is actually disturbed from the camera image of the driver monitor camera 70, and the execution of the stop control may be controlled on the basis of a result of the determination. In this case, the driving state detector 130 extracts, for example, the posture of the driver from a result of an analysis of the camera image of the driver monitor camera 70, and determines that the posture of the driver is disturbed when the extracted posture of the driver has changed from a predetermined basic posture (a posture facing forward) by a predetermined amount or more (for example, when the posture is tilted to a side due to a horizontal G). The stop controller 146 suppresses the execution of the stop control while the driving state detector 130 determines that the posture of the driver is disturbed as the predetermined condition. Note that the stop controller 146 may not suppress the execution of the stop control when the driving state detector 130 determines that the posture of the driver is not disturbed even before a predetermined time has elapsed since the start of the driver steering assistance control. When a state in which the posture of the driver is disturbed remains as it is even after the predetermined time described above has elapsed, the suppression of the execution of the stop control may be continued until the state in which the posture of the driver is disturbed returns to an original state (returns to a basic posture). As a result, it is possible to ascertain the posture of the driver more accurately based on the camera image, and to perform more appropriate driving assistance control according to the posture of the driver.

In the embodiment described above, the accelerator operation of the driver is used as an example of an override determination during the execution of the driver steering assistance control, but a braking operation may be used instead of (or in addition to) the accelerator operation.

In the embodiment described above, the contact avoidance steering control (driver steering assistance control) after the attention calling control (the gradual deceleration control or centering control) is executed has been described, but it may be applied when the driver steering assistance control is executed without performing the attention calling control.

The numerical values shown in the embodiment described above are merely examples, and may be appropriately adjusted according to road conditions (a shape, the number of lanes, and a road type), driving conditions (a degree of carelessness) of the driver, vehicle conditions (a speed, a vehicle type, a shape, and the number of passengers), and the like.

The embodiments described above can be expressed as follows. A vehicle control device includes a storage medium for storing computer-readable instructions and a processor connected to the storage medium, in which the processor executes the computer-readable instructions to recognize surrounding conditions of a vehicle, detect a steering state of an occupant of the vehicle, detect a speed operation of the vehicle by the occupant, determine that there is a possibility of contact between the vehicle and an obstacle on the basis of the recognized surrounding conditions of the vehicle, execute avoidance steering assistance to avoid contact with the obstacle when a steering amount equal to or greater than a first threshold value is detected based on the detected steering state of the occupant, stop the avoidance steering assistance when a speed operation equal to or greater than a second threshold value is detected based on the detected speed operation during the execution of the avoidance steering assistance, and suppress execution of the stop control when a predetermined condition is satisfied during the execution of the avoidance steering assistance.

Although a mode for carrying out the present invention has been described above using the embodiment, the present invention is not limited to the embodiment, and various modifications and substitutions can be made within a range not departing from the gist of the present invention.

What is claimed is:

1. A vehicle control method comprising:
by a computer,
recognizing surrounding conditions of a vehicle,
detecting a steering state of an occupant of the vehicle,
detecting a speed operation of the vehicle by the occupant,
determining that there is a possibility of contact between the vehicle and an obstacle on the basis of the recognized surrounding conditions of the vehicle, executing avoidance steering assistance to avoid contact with the obstacle when a steering amount equal to or greater than a first threshold value is detected based on the detected steering state of the occupant,
executing stop control to stop the avoidance steering assistance when a speed operation equal to or greater than a second threshold value is detected based on the detected speed operation during the execution of the avoidance steering assistance, and
suppressing execution of the stop control when a predetermined condition is satisfied during the execution of the avoidance steering assistance.

2. The vehicle control method according to claim 1,
wherein the predetermined condition includes a predetermined time from a start of the avoidance steering assistance.

3. The vehicle control method according to claim 1,
wherein the predetermined condition includes a steering amount equal to or greater than a third threshold value, which is greater than the first threshold value, detected based on the steering state.

4. The vehicle control method according to claim 1,
wherein, when the execution of the stop control is suppressed, a value of the second threshold value is set to be larger than when the execution of the stop control is not suppressed.

5. The vehicle control method according to claim 4,
wherein the speed operation includes an operation of an accelerator pedal of the vehicle, and
the second threshold value is a threshold value for an opening of the accelerator pedal.

6. The vehicle control method according to claim 4,
wherein the speed operation includes an operation of an accelerator pedal of the vehicle, and
the second threshold value is a threshold value for a rate of change in an opening of the accelerator pedal.

7. The vehicle control method according to claim 1,
wherein the stop control is not executed when the predetermined condition is satisfied during the execution of the avoidance steering assistance.

8. The vehicle control method according to claim 1,
wherein a determination regarding suppression of the stop control using a rate of change in an opening of an accelerator pedal of the vehicle is not executed when the predetermined condition is satisfied during the execution of the avoidance steering assistance.

9. The vehicle control method according to claim 1,
wherein the speed operation includes an operation related to an opening of an accelerator pedal of the vehicle and a rate of change in the opening of the accelerator pedal.

10. A vehicle control device comprising:
a recognizer configured to recognize surrounding conditions of a vehicle; a steering state detector configured to detect a steering state of an occupant of the vehicle;
a speed operation detector configured to detect a speed operation of the vehicle by the occupant;
a steering controller configured to determine that there is a possibility of contact between the vehicle and an obstacle on the basis of the recognized surrounding conditions of the vehicle, and to execute avoidance steering assistance to avoid contact with the obstacle when a steering amount equal to or greater than a first threshold value is detected based on the detected steering state of the occupant; and
a stop controller configured to execute stop control to stop the avoidance steering assistance when a speed operation equal to or greater than a second threshold value is detected based on the speed operation detected by the speed operation detector during execution of the avoidance steering assistance,
wherein the stop controller suppresses execution of the stop control when a predetermined condition is satisfied during the execution of the avoidance steering assistance.

11. A computer-readable non-transitory storage medium that has stored a program causing a computer to execute:
recognizing surrounding conditions of a vehicle,
detecting a steering state of an occupant of the vehicle,
detecting a speed operation of the vehicle by the occupant,
determining that there is a possibility of contact between the vehicle and an obstacle on the basis of the recognized surrounding conditions of the vehicle, executing avoidance steering assistance to avoid contact with the obstacle when a steering amount equal to or greater than a first threshold value is detected based on the detected steering state of the occupant,
executing stop control to stop the avoidance steering assistance when a speed operation equal to or greater than a second threshold value is detected based on the detected speed operation during the execution of the avoidance steering assistance, and
suppressing execution of the stop control when a predetermined condition is satisfied during the execution of the avoidance steering assistance.
